(19) United States
(12) Patent Application Publication
(10) Pub. No.: US 2023/0090897 A1
(43) Pub. Date: Mar. 23, 2023

(54) DATA ANALYSIS REQUIREMENT DEFINITION AID APPARATUS AND DATA ANALYSIS REQUIREMENT DEFINITION AID METHOD

(71) Applicant: Hitachi, Ltd., Tokyo (JP)

(72) Inventors: Shigenori MATSUMOTO, Tokyo (JP); Hiromitsu NAKAGAWA, Tokyo (JP); Kunihiko HARADA, Tokyo (JP); Tsuyoshi TANAKA, Tokyo (JP)

(73) Assignee: Hitachi, Ltd., Tokyo (JP)

(21) Appl. No.: 17/682,511

(22) Filed: Feb. 28, 2022

(30) Foreign Application Priority Data
Sep. 21, 2021 (JP) 2021-153067

(51) Int. Cl. G06F 16/901; G06F 16/903; G06F 16/9038

(52) U.S. Cl. CPC G06F 16/9024; G06F 16/90344; G06F 16/9038

(57) ABSTRACT

A data analysis requirement definition aid apparatus includes a processor configured to execute a program; and a storage device configured to store a plurality of nodes that each include a character string, and an edge indicating a relationship between two nodes among the plurality of nodes, and wherein the processor configures to receive input of a to-be-analyzed node; retrieve, from among the plurality of nodes, a similar node including a character string similar to the character string of the to-be-analyzed node; acquire a directed graph structure constituted of a group of nodes including the similar node, and an edge between two nodes among the group of nodes; search for a path including the similar node from the directed graph structure; and output, in a displayable manner, the directed graph structure so as to display a path in a different format.

### CLAIM OF PRIORITY

The present application claims priority from Japanese patent application JP 2021-153067 filed on Sep. 21, 2021, the content of which is hereby incorporated by reference into this application.

### BACKGROUND

The present invention relates to a data analysis requirement definition aid apparatus and a data analysis requirement definition aid method that supports the defining of requirements for performing data analysis.

Amid the acceleration of progress in data analysis techniques that support digitalization, the use of data analysis techniques for quick decision-making according to data and knowledge management that utilizes on-the-ground know-how for effective decision-making are crucial in quickly creating business value.

Reworking of or delays in the adoption of data analysis techniques can result in the loss of business opportunities, and thus, suitable setting of challenges to be addressed and definition of requirements are needed. Thus, in order to understand the business of customers and derive data analysis measures related to business challenges, it is necessary to clarify the connection to business challenges, and to have related understanding of data such as factors including related business processes and targets, controllable factors, and factors that have an impact.

The problems to be addressed in order to realize this include organizing challenges from the perspective of stakeholders, operation challenges, business processes, and related factors, defining the relatedness thereof, and presenting processes that are determined to be related according to analysis of accumulated data as well as factors to be used in data analysis according to the selected challenge.

JP 2010-256949 A discloses a stakeholder extraction/management device to reduce an extraction failure of a stakeholder, and to present the stakeholder to be checked for specification change. The stakeholder extraction/management device includes: a stakeholder model generation section which structures organization information; a goal model generation section which structures a goal; a business process model generation section which connects a business process with the goal and the stakeholder of a customer and keeps them; a development process model generation section which connects a development process with the stakeholder of a system and keeps them; a various pieces of stakeholder information storage section which keeps stakeholder information; a retrieval section which retrieves the stakeholder in connection with the goal based on a retrieval condition; and an indirect stakeholder extraction processing section which indirectly extracts the stakeholder in connection with the goal through decision making, review, etc.

JP 2012-243194 A discloses a requirement definition support system for data analysis to provide a technique which enables a user to efficiently perform requirement definition processing work. The requirement definition support system for data analysis includes a requirement specification implementation support unit and the like and executes: processing of inputting one of an analysis type, a customer viewpoint, and a presentation system; processing of referring to conditional probabilities (type recommended model) to determine recommended requirement specifications and taking the recommended requirement specifications as a requirement specification candidate; processing of referring to the conditional probabilities to extract similar requirement specifications similar to the requirement specification candidate; processing of visualizing and displaying the requirement specification candidate; processing of visualizing the similar requirement specifications to display them as a list; and processing of allowing the change of the requirement specification candidate in accordance with user's selection from the list.

### SUMMARY

However, JP 2010-256949 A does not consider factors and data types pertaining to control and environmental conditions of processes, such as the business area and development necessary for understanding the data, does not examine in detail the processes handled by each stakeholder according to the role of the stakeholder, and does not include information necessary for data analysis. JP 2012-243194 A only presents a data analysis method on the basis of past relevance according to a request from a customer, and cannot consider restricting conditions that occur during a business process, and if the challenges have not been set well, then the method needs to be reworked.

An object of the present invention is to efficiently aid the structuring of information for defining requirements.

First aspect of disclosure in this application is a data analysis requirement definition aid apparatus, comprising: a processor configured to execute a program; and a storage device configured to store the program, wherein the storage device configures to store a plurality of nodes that each include a character string, and an edge indicating a relationship between two nodes among the plurality of nodes, and wherein the processor configures to execute: an input process of receiving input of a to-be-analyzed node; a retrieval process of retrieving, from among the plurality of nodes, a similar node including a character string similar to the character string of the to-be-analyzed node inputted by the input process; an acquisition process of acquiring a directed graph structure constituted of a group of nodes including the similar node retrieved through the retrieval process, and an edge between two nodes among the group of nodes; a search process of searching for a path including the similar node from the directed graph structure acquired by the acquisition process; and an output process of outputting, in a displayable manner, the directed graph structure so as to display a path found by the search process in a different format.

Second aspect of disclosure in this application is a data analysis requirement definition aid apparatus, comprising: a processor configured to execute a program; and a storage device configured to store the program, wherein the storage device configured to store a plurality of nodes that each include a character string, an edge indicating a relationship between two nodes among the plurality of nodes, and a history of the nodes referred to by a to-be-analyzed person, and wherein the processor configured to execute: an input process of receiving input of a first to-be-analyzed directed graph structure constituted of a to-be-analyzed group of nodes and an edge indicating a relationship between two nodes among the to-be-analyzed group of nodes; a first retrieval process of retrieving, from among the plurality of nodes, a first similar node that was referred to by the to-be-analyzed person and that is similar to the character string of each to-be-analyzed node among the to-be-analyzed group of nodes that constitutes the first to-be-analyzed directed graph structure inputted by the input process; a first setting process of setting, as a first specific display object, a first similar to-be-analyzed node that is similar to the first similar node retrieved by the first retrieval process among the to-be-analyzed group of nodes; and an output process of outputting, in a displayable manner, the first to-be-analyzed directed graph structure so as to display the first specific display object set by the first setting process in a different format.

Third aspect of disclosure in this application is a data analysis requirement definition aid apparatus, comprising: a processor configured to execute a program; and a storage device configured to store the program, wherein the storage device configures to store a plurality of nodes that each include a character string, and an edge indicating a relationship between two nodes among the plurality of nodes, and wherein the processor configured to execute: an input process of receiving input of a to-be-analyzed directed graph structure constituted of a to-be-analyzed group of nodes and an edge indicating a relationship between two nodes among the to-be-analyzed group of nodes; an acquisition process of acquiring a degree of priority of the edge; a first search process of searching for a path having a greatest total degree of priority of the edges, from among the to-be-analyzed directed graph structure, on the basis of the degree of priority acquired by the acquisition process for each edge of the to-be-analyzed directed graph structure inputted by the input process; and an output process of outputting, in a displayable manner, the to-be-analyzed directed graph structure so as to display a path found by the first search process in a different format.

According to a representative embodiment of the present invention, it is possible to efficiently aid the structuring of information to define requirements. Other objects, configurations, and effects than those described above are clarified by the following description of an embodiment.

### BRIEF DESCRIPTION OF THE DRAWINGS

FIG. 1 is a descriptive view showing a data analysis requirement definition aid example 1.

FIG. 2 is a descriptive view showing a data analysis requirement definition aid example 2.

FIG. 3 is a descriptive view showing a data analysis requirement definition aid example 3.

FIG. 4 is a descriptive view showing a system configuration example of the data analysis requirement definition aid system.

FIG. 5 is a block diagram for illustrating a hardware configuration example of each of information processing apparatuses.

FIG. 6 is a block diagram showing a functional configuration example of the data analysis requirement definition aid apparatus.

FIG. 7 is a descriptive view showing an example of the stakeholder table.

FIG. 8 is a descriptive view showing an example of the stakeholder relationship table.

FIG. 9 is a descriptive view showing an example of the stakeholder value table.

FIG. 10 is a descriptive view showing an example of the challenge/stakeholder/factor relationship table.

FIG. 11 is a descriptive view showing an example of the challenge relationship table.

FIG. 12 is a descriptive view showing an example of the challenge priority table.

FIG. 13 is a descriptive view showing an example of the process/stakeholder/factor relationship table.

FIG. 14 is a descriptive view showing an example of the process relationship table.

FIG. 15 is a descriptive view showing an example of the factor table.

FIG. 16 is a descriptive view showing an example of the process carrier table.

FIG. 16 is a descriptive view showing an example of the process carrier table.

FIG. 17 is a descriptive view showing an example of the user information table.

FIG. 18 is a descriptive view showing an example of the selection history table.

FIG. 19 is a flowchart showing data analysis requirement definition aid process method example 1.

FIG. 20 is a flowchart showing data analysis requirement definition aid process method example 2.

FIG. 21 is a flowchart showing data analysis requirement definition aid process method example 3.

### DETAILED DESCRIPTION OF THE EMBODIMENTS

### DATA ANALYSIS REQUIREMENT DEFINITION AID EXAMPLE

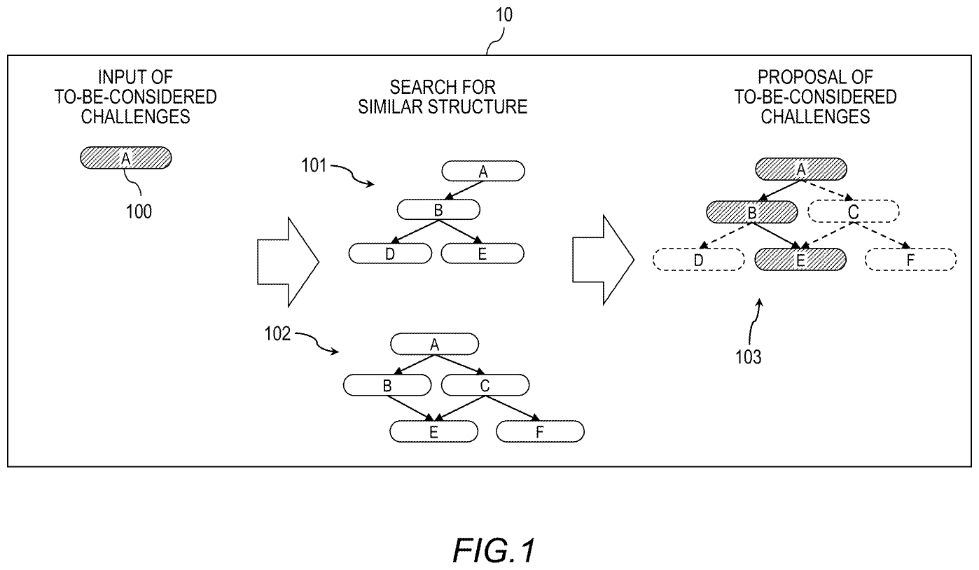

First, an example of data analysis requirement definition aid in a data analysis requirement definition aid system will be described with reference to FIGS. 1 to 3. Data analysis requirement definition aid refers to aiding of the definition of data analysis requirements. Defining of data analysis requirements refers to defining necessary requirements for data analysis.

Highlighted display refers to display in which data to be highlighted is displayed differently from non-highlighted data so as to be conspicuous, and specifically, refers to a display format in which the data to be highlighted is displayed with a darker color, with a bolder typeface, or with lower transparency than non-highlighted data, for example. Deemphasized display, unlike highlighted display, refers to display in which data to be deemphasized is displayed differently from data not subject to deemphasis so as not to be conspicuous, and specifically, refers to a display format in which the data to be deemphasized is displayed with a lighter color, with a thinner typeface, with greater transparency, or with dotted display, or is not displayed at all, by contrast to the data not subject to deemphasis, for example.

### Data Analysis Requirement Definition Aid Example 1

FIG. 1 is a descriptive view showing a data analysis requirement definition aid example 1. The data analysis requirement definition aid example 1 is an example of aiding of the definition of data analysis requirements by presenting a similar challenge structure according to a plurality of example cases. In FIG. 1, the capital letters are words including one or more letters. The rounded rectangles are nodes indicating challenges, and the arrows between the nodes are edges indicating the relationship between nodes on both ends thereof.

The data analysis requirement definition aid system 10 accumulates a plurality of case examples represented by a directed graph structure having nodes and edges (e.g., in FIG. 1, accumulated challenges 101 of case 1 and accumulated challenges 102 of case 2). When a challenge 100 is inputted, the data analysis requirement definition aid system 10 retrieves accumulated challenges with the challenge 100 as a starting point. In this example, the accumulated challenges 101 of case 1 and the accumulated challenges 102 of case 2 are retrieved.

The data analysis requirement definition aid system 10 extracts common challenges 103 that are the portions in common between the accumulated challenges 101 of case 1 and the accumulated challenges 102 of case 2, and that include the challenge 100. In the example of FIG. 1, the common challenges 103 are a common path constituted of node A→node B→node E. The data analysis requirement definition aid system 10 displays the extracted common challenges 103. As a result, the common challenges 103 can be proposed to the user as a similar challenge structure.

### Data Analysis Requirement Definition Aid Example 2

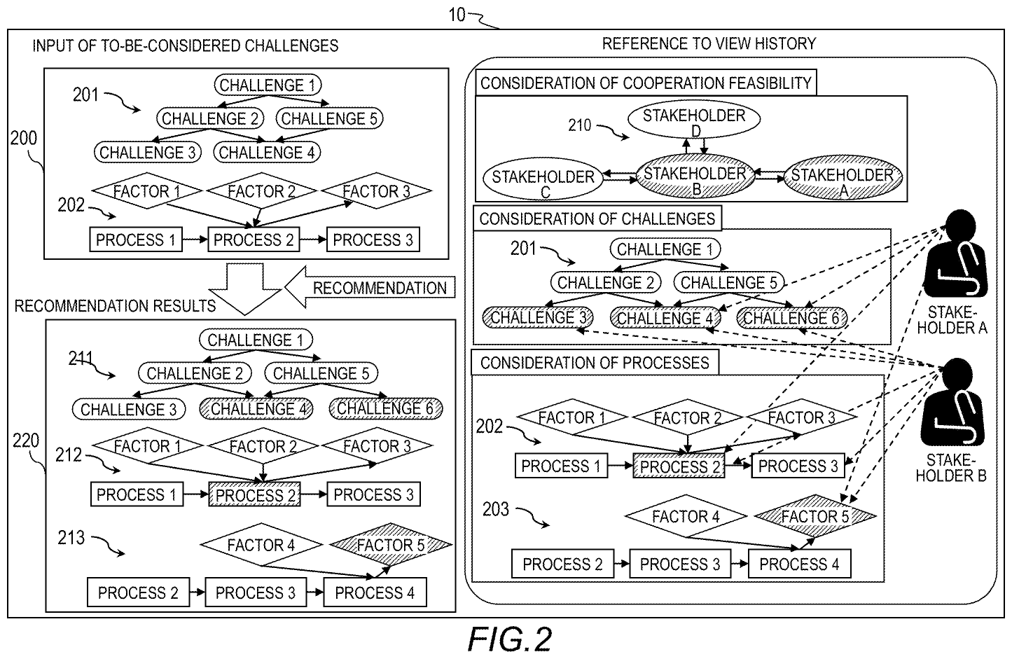

FIG. 2 is a descriptive view showing a data analysis requirement definition aid example 2. A data analysis requirement definition aid example 2 is an example of aiding of the definition of data analysis requirements by presenting highly related items from the consideration history of another person. In FIG. 2, the rectangles are nodes indicating processes, and the diamonds are nodes indicating factors. The arrows between the nodes are edges indicating the relationship between nodes on both ends thereof.

The data analysis requirement definition aid system 10 receives input of to-be-analyzed data 200 from the user. The to-be-analyzed data 200 includes to-be-considered challenges 201 and to-be-considered processes 202. Also, in FIG. 2, in a stakeholder graph 210, the stakeholders A and B are selected by the user as stakeholders for collaboration feasibility analysis.

Then, the data analysis requirement definition aid system 10 records a history of access to the to-be-analyzed data 200 by the stakeholders A and B who have a vested interest. In the example of FIG. 2, the data analysis requirement definition aid system 10 records challenges 4 and 6 among the to-be-considered challenges 201 viewed by the stakeholder A and challenges 3, 4, and 6 among the to-be-considered challenges 201 viewed by the stakeholder B.

Similarly, the data analysis requirement definition aid system 10 records a process 2 among the to-be-considered processes 202 viewed by the stakeholder A and processes 2 and 3 among the to-be-considered processes 202 viewed by the stakeholder B.

Also, the data analysis requirement definition aid system 10 records data having items viewed by the stakeholders A and B and, in the example of FIG. 2, other to-be-considered processes 203 and a factor 5 thereof even if these are outside of the to-be-analyzed data 200.

The data analysis requirement definition aid system 10 extracts the challenges 4 and 6 of the to-be-considered challenges 201, the process 2 of the to-be-considered processes 202, and the factor 5 of other to-be-considered processes 203 as items viewed by both stakeholders A and B.

The data analysis requirement definition aid system 10 recommends items viewed by the stakeholders A and B to the user who inputted the to-be-analyzed data 200. Specifically, for example, the data analysis requirement definition aid system 10 displays, as recommendation information 220, to-be-considered challenges 211 in which the challenges 4 and 6 viewed by the stakeholders A and B are displayed with emphasis among the to-be-considered challenges 201, to-be-considered processes 212 in which the process 2 is displayed with emphasis among the to-be-considered processes 202, and other to-be-considered processes 213 in which the factor 5 is displayed with emphasis.

As a result, the user is able to know which items among the to-be-analyzed data 200 were viewed by the stakeholders A and B who have a vested interest. Also, the user is able to know which items among other considerations were viewed by the stakeholders A and B who have a vested interest.

### Data Analysis Requirement Definition Aid Example 3

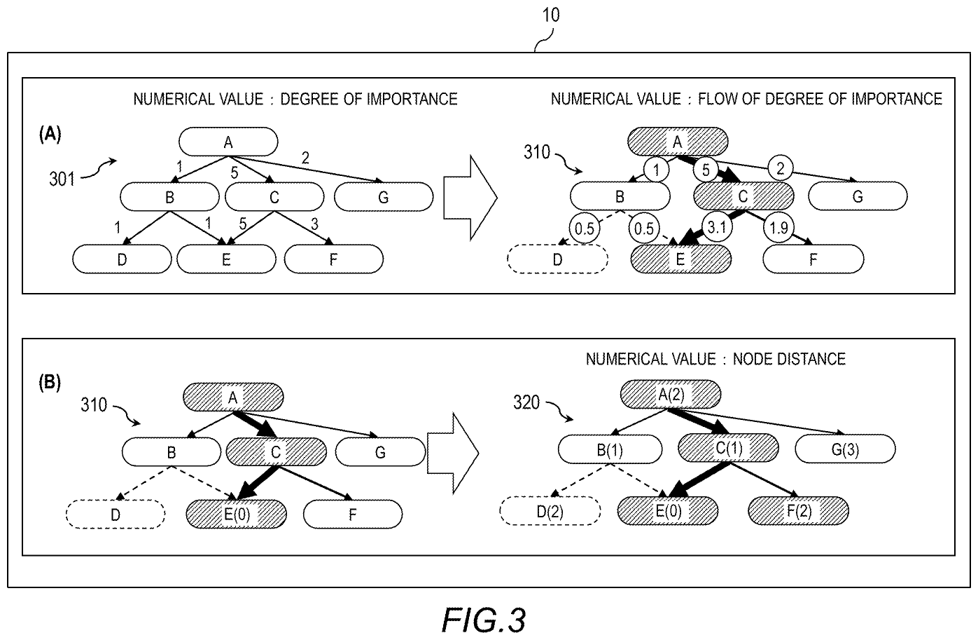

FIG. 3 is a descriptive view showing a data analysis requirement definition aid example 3. The data analysis requirement definition aid example 3 is an example of aiding of the definition of data analysis requirements by presenting the value of a to-be-considered challenge by weighting the degree of priority of the to-be-considered challenge. (A) indicates the presentation of a challenge value by degree of importance and (B) indicates the presentation of a challenge value by node distance. Here, an edge that connects a starting node X with an ending node Y is referred to as an edge XY.

In (A), each edge of the directed graph structure indicating the to-be-considered challenges 301 is assigned a degree of importance. Here, the greater the value is, the more important the edge is.

The data analysis requirement definition aid system 10 converts the degree of importance of a downstream edge to a degree of priority indicating the connection of the challenge values on the basis of the degree of importance of an upstream edge. The to-be-considered challenges 301 after conversion to degree of priority are referred to as the to-be-considered challenges 310. The degree of priority is indicated as circled numbers. The degrees of priority for edges AB and AC that are the furthest upstream are the same as the degrees of importance.

The degrees of importance of the edges BD and BE are normalized by the degree of importance of the edge AB, which is upstream thereof. As a result, the degrees of priority of the edges BD and BE are both “0.5.” Similarly, the degrees of importance of the edges CE and CF are normalized by the degree of importance of the edge AC, which is upstream thereof. As a result, the degrees of priority of the edges CE and CF are, respectively, “3.1” and “1.9.”

The data analysis requirement definition aid system 10 identifies an edge group with the greatest total of the degrees of priority from the starting point node A, and displays the edge group with emphasis. In the case of the to-be-considered challenges 310, the total of the degrees of priority for A→C→E is the greatest, at “8.1.” Thus, the data analysis requirement definition aid system 10 displays the edges AC and CE so as to be bolder than other edges, for example.

Also, a threshold may be set for the degree of priority. The data analysis requirement definition aid system 10 displays, with less emphasis than other edges, edges where the degree of priority is less than or equal to the threshold. In the to-be-considered challenges 310, if the threshold were set to “0.5,” for example, the degrees of priority of the edges BD and BE are both “0.5,” and thus, the edges BD and BE are displayed as dotted lines.

Also, the data analysis requirement definition aid system 10 displays, with less emphasis than other nodes, nodes where the total degree of priority of edges having an end connected thereto is less than or equal to the threshold. In the to-be-considered challenges 310, if the threshold were set to “0.5,” for example, the only edge having an end connected to the node D is the edge BD, and the degree of priority of the edge DB is “0.5,” and thus, the node D is displayed as a dotted line. Meanwhile, the edges having ends connected to the node E are the edges BE and CE, and the degrees of priority of the edges BE and CE are “0.5” and “3.1,” respectively, and thus, the total is “3.6.” Therefore, the total degree of priority is not less than or equal to the threshold, thus, the node is not displayed with a dotted line. The edge BD and the node D displayed with dotted lines can be set not to be displayed by being collapsed by user operation.

In (B), the data analysis requirement definition aid system 10 receives selection from the user of the node of a target challenge among the to-be-considered challenges 310. Here, the node E is selected as the target challenge, and is therefore the target node. The data analysis requirement definition aid system 10 sets the node distance of the selected target node to “0,” which signifies the starting point. The node distances are represented by the numbers in parentheses in the nodes.

The data analysis requirement definition aid system 10 calculates, as the challenge value, the node distance from the target node for each node, where one edge is equal to one node distance unit. The to-be-considered challenges 310 after calculation of the node distances are referred to as the to-be-considered challenges 320.

The data analysis requirement definition aid system 10 displays, with emphasis, nodes where the degree of priority in (A) is greater than or equal to the threshold and where the node distance is less than or equal to a threshold, as candidates with high challenge values. If, similar to (A), the threshold for the degree of priority is set to “0.5” and the threshold for the node distance is set to “2,” for example, the node F has a degree of priority of “1.9” and a node distance of “2,” and thus, is displayed with emphasis as a candidate with a high challenge value. On the other hand, the node G has a degree of priority of “2” but a node distance of “3,” and thus, is not displayed with emphasis as a candidate with a high challenge value.

Thus, the user can see which connection of challenges is important. In this manner, the data analysis requirement definition aid system 10 can aid the structuring of information for quickly and effectively defining requirements for new cases through the data analysis requirement definition aid examples 1 to 3.

<System Configuration Example>

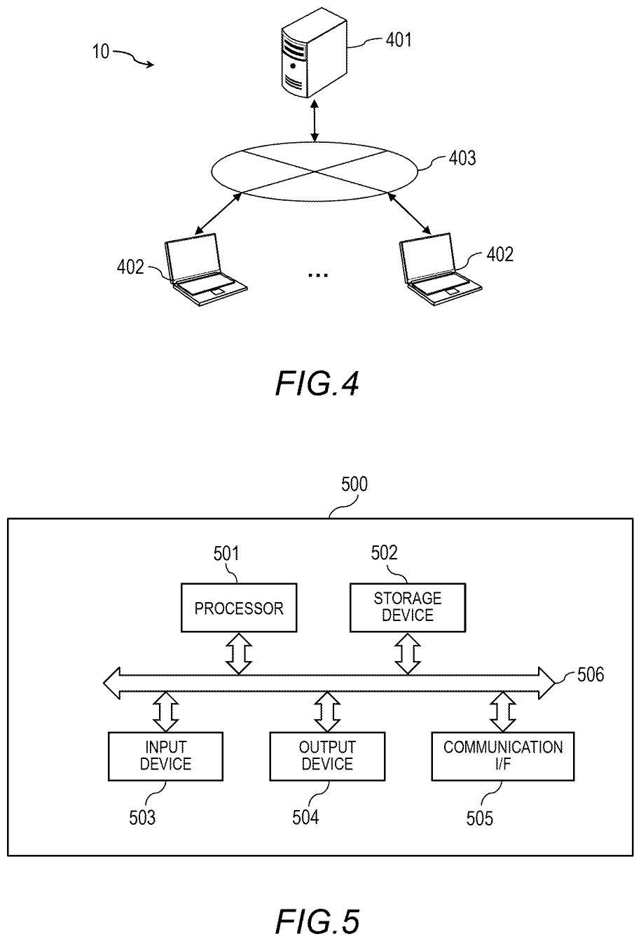

FIG. 4 is a descriptive view showing a system configuration example of the data analysis requirement definition aid system 10. The data analysis requirement definition aid system 10 includes a data analysis requirement definition aid apparatus 401 and one or more terminals 402. The data analysis requirement definition aid apparatus 401 and the terminals 402 are connected in a manner enabling communication therebetween via a network 403 such as the internet, a LAN (local area network), or a WAN (wide area network).

<Hardware Configuration Example of Information Processing Apparatuses (the Data Analysis Requirement Definition Aid Apparatus 401 and the Terminal 402)>

FIG. 5 is a block diagram for illustrating a hardware configuration example of each of information processing apparatus. Information processing apparatuses 500 include a processor 501, a storage device 502, an input device 503, an output device 504, and a communication interface (communication IF) 505. The processor 501, the storage device 502, the input device 503, the output device 504, and the communication IF 505 are coupled to one another through a bus 506. The processor 501 is configured to control the information processing apparatuses 500. The storage device 502 serves as a work area for the processor 501. The storage device 502 is also a non-transitory or transitory recording medium configured to store various programs and various kinds of data. Examples of the storage device 502 include a read only memory (ROM), a random access memory (RAM), a hard disk drive (HDD), and a flash memory. The input device 503 is configured to input data. Examples of the input device 503 include a keyboard, a mouse, a touch panel, a numeric keypad, a scanner and a sensor. The output device 504 is configured to output data. Examples of the output device 504 include a display, a printer, and a speaker. The communication IF 505 is coupled to the network 110, and is configured to transmit and receive data.

<Functional Configuration Example of Data Analysis Requirement Definition Aid Apparatus 401>

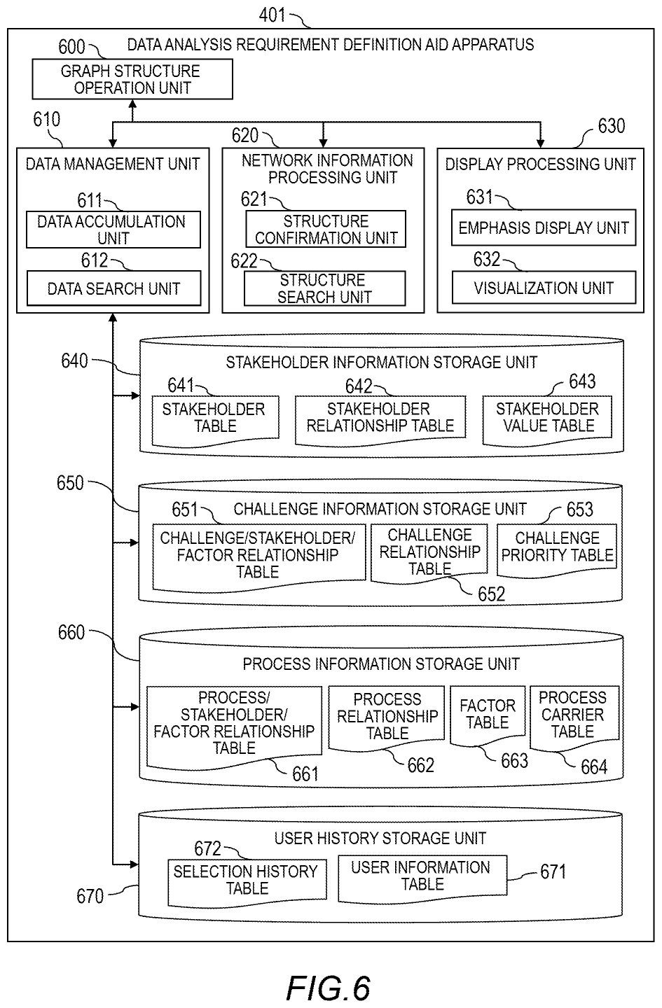

FIG. 6 is a block diagram showing a functional configuration example of the data analysis requirement definition aid apparatus 401. The data analysis requirement definition aid apparatus 401 has a graph structure operation unit 600, a data management unit 610, a network information processing unit 620, a display processing unit 630, a stakeholder information storage unit 640, a challenge information storage unit 650, a process information storage unit 660, and a user history storage unit 670.

The graph structure operation unit 600, the data management unit 610, the network information processing unit 620, and the display processing unit 630 are specifically realized by a processor 501 executing programs stored in a storage device 502 shown in FIG. 5, for example. The stakeholder information storage unit 640, the challenge information storage unit 650, the process information storage unit 660, and the user history storage unit 670 specifically are realized by the storage device 502 shown in FIG. 5, for example.

The graph structure operation unit 600 operates the directed graph structure interactively with the user as a result of the user operating an input device 503. The graph structure operation unit 600 receives data creation instructions from the user, storage instruction for the created data, input of retrieval conditions, and retrieval instructions.

The data management unit 610 has a data accumulation unit 611 and a data retrieval unit 612. Upon receiving a data creation instruction from the graph structure operation unit 600, the data management unit 610 calls data from the stakeholder information storage unit 640, the challenge information storage unit 650, and the process information storage unit 660, and outputs accumulated stakeholders, challenges, processes, and factor information candidates to the display processing unit 630. When data creation by the user is complete and the user performs a saving operation using the graph structure operation unit 600, the data management unit 610 uses the data accumulation unit 611 to save the created data in the stakeholder information storage unit 640, the challenge information storage unit 650, and the process information storage unit 660.

Upon receiving a retrieval condition input from the graph structure operation unit 600, the data management unit 610 uses the data retrieval unit 612 to call data from the stakeholder information storage unit 640, the challenge information storage unit 650, and the process information storage unit 660, retrieve accumulated stakeholders, challenges, processes, and factor information candidates, and output the retrieval results to the display processing unit 630.

The network information processing unit 620 has a structure confirmation unit 621 and a structure retrieval unit 622. If the user uses the graph structure operation unit 600 to select a candidate or add new data, then the network information processing unit 620 uses the structure confirmation unit 621 to confirm the connections between the stakeholders, the challenges, the processes, and the factors, and output the confirmation results to the display processing unit 630. Also, the network information processing unit 620 uses the structure retrieval unit 622 to retrieve a directed graph structure operated by the graph structure operation unit 600 from the stakeholder information storage unit 640, the challenge information storage unit 650, and the process information storage unit 660, and output the retrieval results to the display processing unit 630.

The display processing unit 630 outputs the output results from the graph structure operation unit 600, the data management unit 610, and the network information processing unit 620 via a communication I/F 505 to the terminal 402 in a manner enabling display, or to an output device 504 in a manner enabling display. Specifically, for example, the display processing unit 630 outputs to the terminal 402, in a displayable manner, the common challenges 103 shown in FIG. 1, the recommendation information 220 shown in FIG. 2, and the to-be-considered challenges 301, 310, and 320 shown in FIG. 3, and displays the foregoing in the terminal 402.

The stakeholder information storage unit 640 has a stakeholder table 641, a stakeholder relationship table 642, and a stakeholder value table 643. The challenge information storage unit 650 has a challenge/stakeholder/factor relationship table 651, a challenge relationship table 652, and a challenge priority table 653. The process information storage unit 660 has a process/stakeholder/factor relationship table 661, a process relationship table 662, a factor table 663, and a process carrier table 664. The user history storage unit 670 has a user information table 671 and a selection history table 672.

<Stored Content of Stakeholder Information Storage Unit 640>

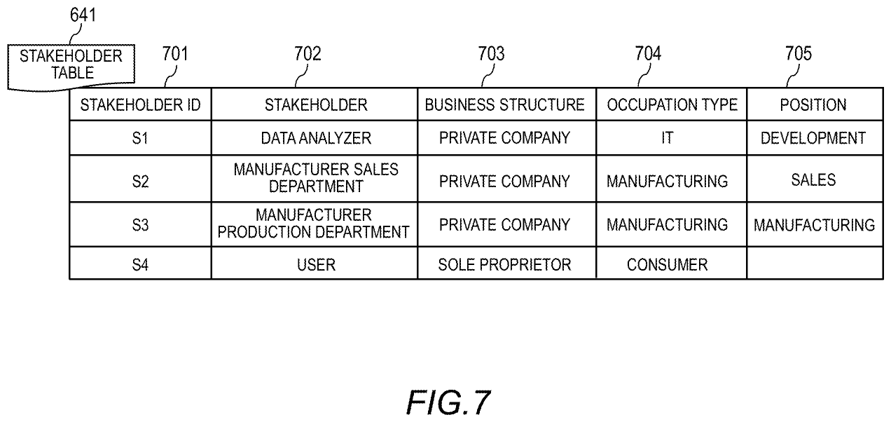

FIG. 7 is a descriptive view showing an example of the stakeholder table 641. The stakeholder table 641 has, as fields, a stakeholder ID 701, a stakeholder 702, a business structure 703, an occupation type 704, and a position 705. The combination of values of the fields 701 to 705 in the same row constitutes information pertaining to one stakeholder 702 (hereinafter referred to as the stakeholder information).

The stakeholder ID 701 is identification information that uniquely identifies the stakeholder 702. The stakeholder 702 is a person with a vested interest. The stakeholder 702 may be a common term, a corporation, or an individual such as “data analyzer” or “manufacturer sales department.” The business structure 703 is the structure of the business conducted by the stakeholder 702. The occupation type 704 is the type of occupation held by the stakeholder 702. The position 705 is the position held by the stakeholder 702 within an organization.

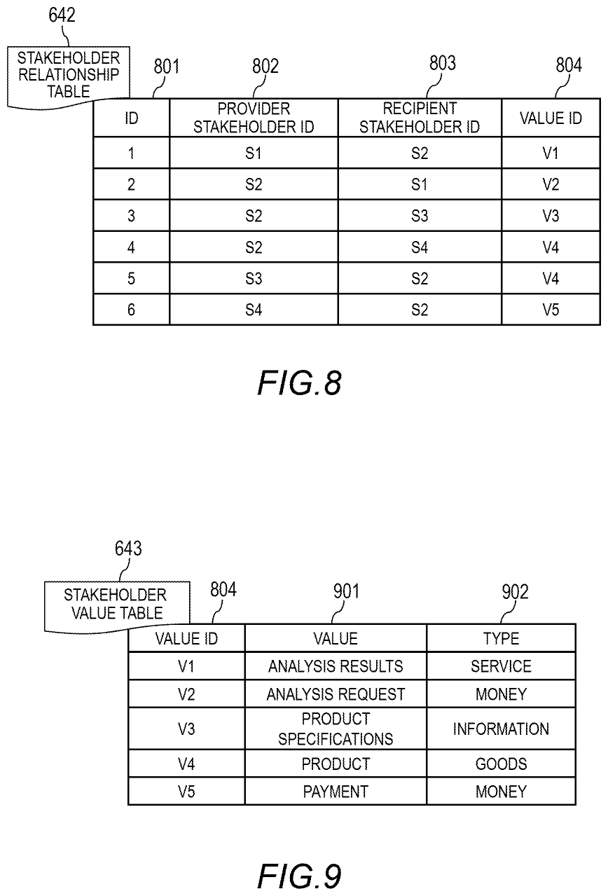

FIG. 8 is a descriptive view showing an example of the stakeholder relationship table 642. The stakeholder relationship table 642 has, as fields, an ID 801, a provider stakeholder ID 802, a recipient stakeholder ID 803, and a value ID 804. The combination of values of the fields 801 to 804 in the same row constitutes stakeholder relationship information having one set of two stakeholders 702. The provider stakeholder ID 802 and the recipient stakeholder ID 803 in the stakeholder relationship information identify the edge between the stakeholders 702.

The ID 801 is identification information that uniquely identifies the stakeholder relationship information. The provider stakeholder ID 802 is the stakeholder ID 701 of the stakeholder 702 who is the provider of value 902 (see FIG. 9). The recipient stakeholder ID 803 for the value 902 is the stakeholder ID 701 of the stakeholder 702 who is the recipient. The value ID 804 is identification information that uniquely identifies the value 902.

FIG. 9 is a descriptive view showing an example of the stakeholder value table 643. The stakeholder value table 643 has, as fields, a value ID 804, the value 901, and a type 902. The combination of values of the fields 804, 901, and 902 in the same row constitutes value information pertaining to the stakeholder relationship information. The value 901 is the item transacted between the stakeholders 702 defined by the stakeholder relationship information. The type 902 is the type of value 901.

<Stored Content of Challenge Information Storage Unit 650>

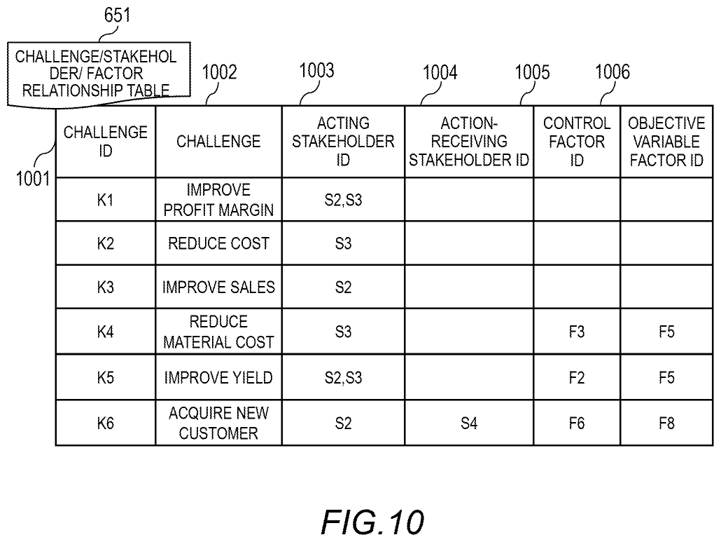

FIG. 10 is a descriptive view showing an example of the challenge/stakeholder/factor relationship table 661. The challenge/stakeholder/factor relationship table 661 has, as fields, a challenge ID 1001, a challenge 1002, an acting stakeholder ID 1003, an action-receiving stakeholder ID 1004, a control factor ID 1005, and an objective variable factor ID 1006. The combination of values of the fields 1001 to 1006 in the same row constitutes the challenge/stakeholder/factor relationship information indicating the relationship between the challenge 1002, the stakeholder 702, and the factor 1502 (see FIG. 15).

The challenge ID 1001 is identification information that uniquely identifies the challenge 1002. The challenge 1002 is a problem to be solved or a goal to be achieved by the stakeholder 702 (acting stakeholder 702) for the stakeholder 702 (action-receiving stakeholder 702). The challenge 1002 is each node A to F shown in FIG. 1, for example.

The acting stakeholder ID 1003 is identification information that uniquely identifies the acting stakeholder 702. The acting stakeholder 702 is the stakeholder 702 who acts on the challenge 1002. The action-receiving stakeholder ID 1004 is identification information that uniquely identifies the action-receiving stakeholder 702. The action-receiving stakeholder 702 is the stakeholder 702 who is the recipient of action taken regarding the challenge 1002.

The control factor ID 1005 is identification information that uniquely identifies the control factor. The control factor 1502 is the factor 1502 that controls the challenge 1002. The objective variable factor ID 1006 is identification information that uniquely identifies the objective variable factor 1502. The objective variable factor 1502 is a factor 1502 that is the objective variable of the challenge 1002. If, for example, the challenge 1002 is “material cost reduction,” the objective variable factor 1502 is a target value for the material cost to be reduced. Also, the control factor 1502 is a factor indicating an explanatory variable for the objective variable factor 1502. If, for example, the challenge 1002 is “material cost reduction,” the control factor 1502 is the material to be subject to cost reduction and the quantity of the material.

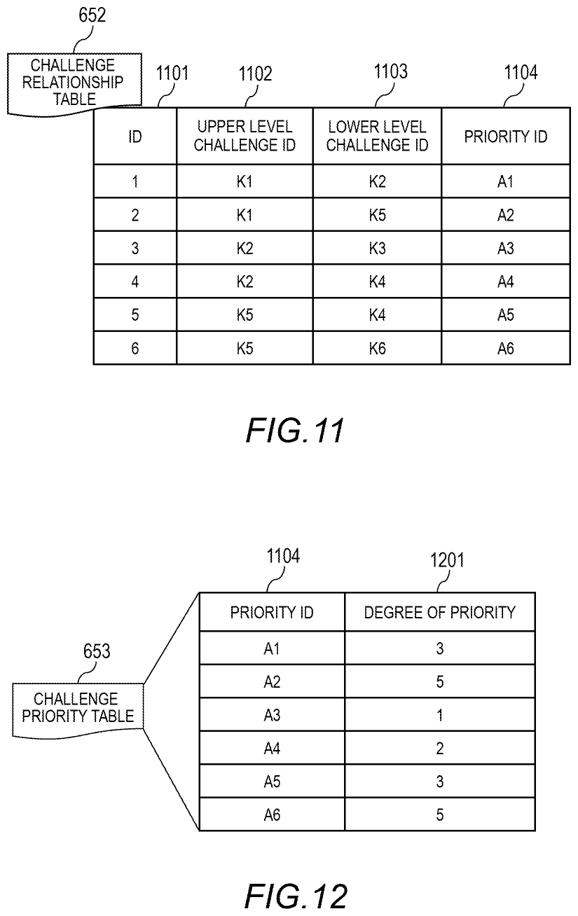

FIG. 11 is a descriptive view showing an example of the challenge relationship table 652. The challenge relationship table 652 has, as fields, an ID 1101, an upper level challenge ID 1102, a lower level challenge ID 1103, and a priority ID 1104. The combination of values of the fields 1101 to 1104 in the same row constitutes challenge relationship information indicating the relationship between two challenges 1002. The challenge relationship information is the edges shown in shown in FIGS. 1 and 3.

The ID 1101 is identification information that uniquely identifies the challenge relationship information. The upper level challenge ID 1102 is the challenge ID 1001 of the upper level challenge 1002 (hereinafter referred to as the upper level challenge 1002). The lower level challenge ID 1103 is the challenge ID 1001 of the lower level challenge 1002 (hereinafter referred to as the lower level challenge 1002). The upper level challenge 1002 is a node on the starting side of the arrow indicating the edge in FIGS. 1 and 3, for example, and the lower level challenge 1002 is the node on the ending side of the arrow indicating the edge from the upper level challenge 1002 in FIGS. 1 and 3, for example. The priority ID 1104 is the degree of priority 1202 of the challenge relationship information (see FIG. 12).

FIG. 12 is a descriptive view showing an example of the challenge priority table 653. The challenge priority table 653 has the priority ID 1104 and a degree of priority 1201. The degree of priority 1201 is a relative value indicating whether the challenge relationship information that is an entry of FIG. 11 should be placed before (i.e., the degree of importance is high) or after (i.e., the degree of importance is low) other pieces of challenge relationship information. The degree of priority 1201 is the value of each of the circled numbers assigned to edges shown in FIG. 3.

<Stored Content of Process Information Storage Unit 660>

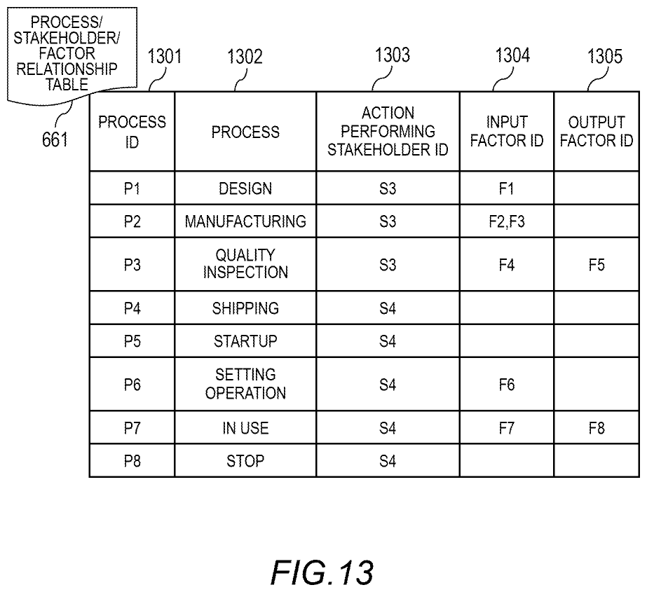

FIG. 13 is a descriptive view showing an example of the process/stakeholder/factor relationship table 661. The process/stakeholder/factor relationship table 661 has, as fields, a process ID 1301, a process 1302, an action-performing stakeholder ID 1303, an input factor ID 1304, and an output factor ID 1305. The combination of values of the fields 1301 to 1305 in the same row constitutes the process/stakeholder/factor relationship information indicating the relationship between the process 1302, the stakeholder 702, and the factor 1502.

The process ID 1301 is identification information that uniquely identifies the process 1302. The process 1302 indicates tasks and procedures for achieving the to-be-considered challenges 201 in which the plurality of challenges 1002 have been put in a tree structure by challenge relationship information.

The action-performing stakeholder ID 1303 is the stakeholder ID 701 of the stakeholder 702 who is the performer of the action (action-performing stakeholder 702). The action-performing stakeholder 702 is the stakeholder 702 who applies the factor 1502 to the process 1302. The input factor ID 1304 is a factor ID 1501 (see FIG. 15) of the factor 1502 (hereinafter referred to as the input factor 1502) applied to the process 1302 by the action-performing stakeholder 702. The output factor ID 1305 is a factor ID 1501 of the factor 1502 (hereinafter referred to as the output factor 1502) that is outputted from the process 1302 to which the input factor 1502 was applied.

For example, in the to-be-considered processes 202 of FIG. 2, the “factor 1” and the “factor 2” applied to the “process 2” are the input factors 1502, and the “factor 3” outputted from the “process 2” is the output factor 1502.

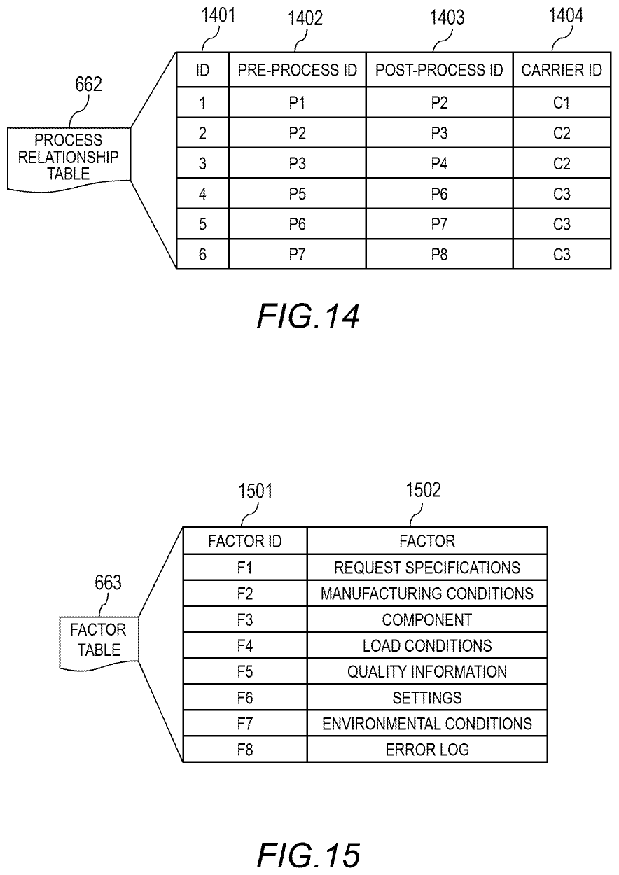

FIG. 14 is a descriptive view showing an example of the process relationship table 662. The process relationship table 662 has, as fields, an ID 1401, a pre-process ID 1402, a post-process ID 1403, and a carrier ID 1404. The combination of values of the fields 1401 to 1404 in the same row constitutes process relationship information indicating the relationship between two consecutive processes 1302. The process relationship information is the edges of the to-be-considered processes 202 that constitute the directed graph structure of the processes shown in FIG. 2, for example.

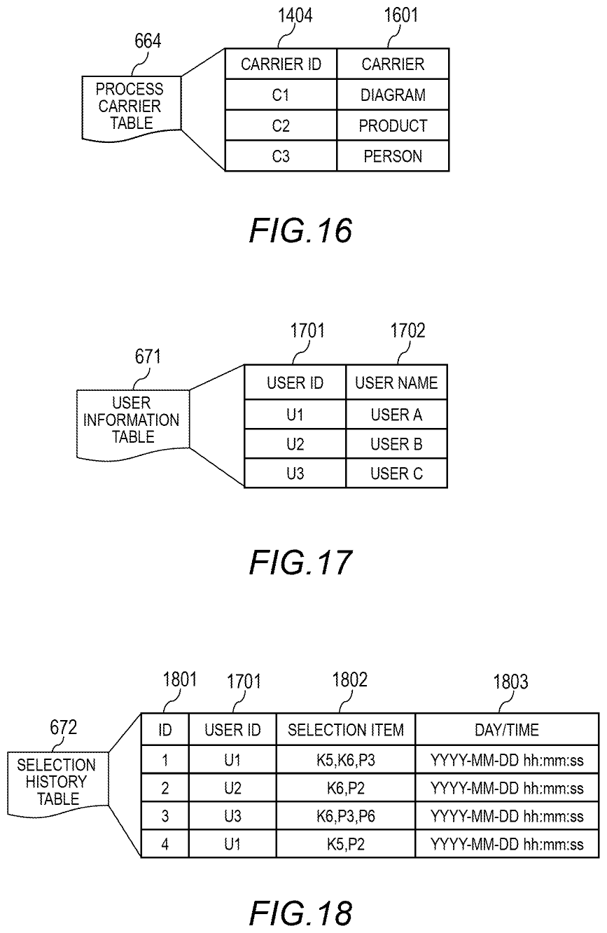

The ID 1401 is identification information that uniquely identifies the process relationship information. The pre-process ID 1402 is the process ID 1301 of the process 1302 appearing first among the two consecutive processes. The post-process ID 1403 is the process ID 1301 of the process 1302 appearing second among the two consecutive processes. The carrier ID 1404 is identification information that uniquely identifies a carrier 1601 (see FIG. 16).

FIG. 15 is a descriptive view showing an example of the factor table 663. The factor table 663 has, as fields, the factor ID 1501 and the factor 1502. The factor 1502 is an element inputted to the process 1302 or outputted from the process 1302.

FIG. 16 is a descriptive view showing an example of the process carrier table 664. The process carrier table 664 has, as fields, the carrier ID 1404 and the carrier 1601. The carrier 1601 is a collective term for persons, goods, information, and the like flowing between two consecutive processes 1302.

<Stored Content of User History Storage Unit 670>

FIG. 17 is a descriptive view showing an example of the user information table 671. The user information table 671 has, as fields, a user ID 1701 and a user name 1702. The combination of values of the fields 1701 and 1702 in the same row constitutes user information. The user ID 1701 is identification information that uniquely identifies a user who uses the data analysis requirement definition aid apparatus 401 by operating the terminal 402. The user ID 1701 is also used as the stakeholder ID 701. The user name 1702 is the name of the user identified by the user ID 1701.

FIG. 18 is a descriptive view showing an example of the selection history table 672. The selection history table 672 has, as fields, an ID 1801, the user ID 1701, a selection item 1802, and a day/time 1803. The combination of values of the fields 1801 to 1803 and 1701 in the same row constitutes selection history information.

The ID 1801 is identification information that uniquely identifies the selection history information. The selection item 1802 is an ID of an item (challenge 1002, process 1302, factor 1502) selected by the user identified by the user ID 1701. The day/time 1803 is the day and time at which the user identified by the user ID 1701 selected the selection item 1802.

### DATA ANALYSIS REQUIREMENT DEFINITION AID PROCESS METHOD

### Data Analysis Requirement Definition Aid Example 1

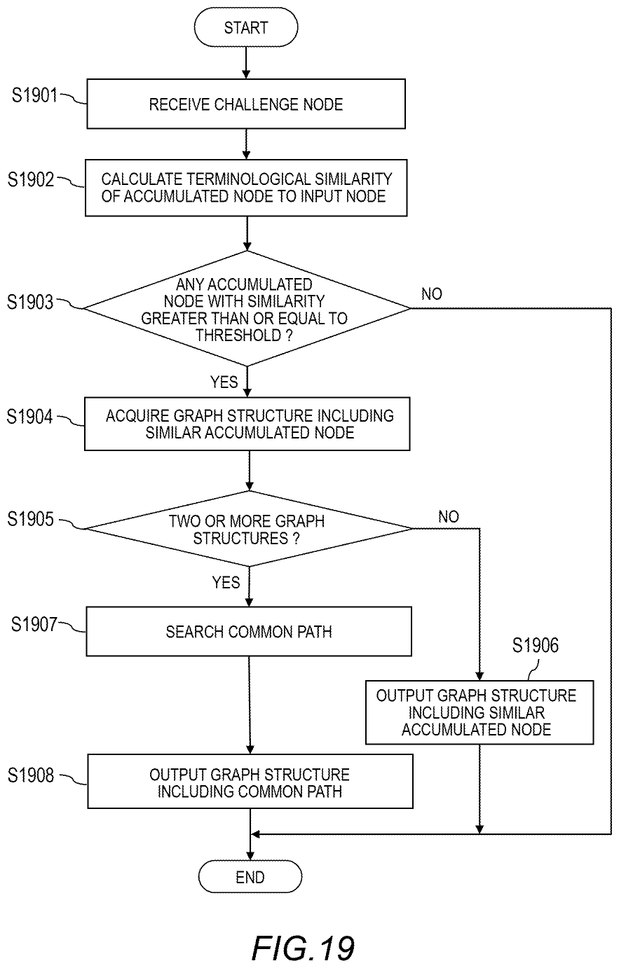

FIG. 19 is a flowchart showing data analysis requirement definition aid process method example 1. FIG. 19 shows a process method corresponding to the data analysis requirement definition aid example 1 shown in FIG. 1.

The data analysis requirement definition aid apparatus 401 receives input of a node (e.g., the challenge 100 of FIG. 1) from the graph structure operation unit 600 through operation of the terminal 402 by the user (step S1901).

Next, the data analysis requirement definition aid apparatus 401 calculates the terminological similarity of accumulated nodes to the input node (step S1902). The data analysis requirement definition aid apparatus 401 calculates, for each challenge 1002 of the challenge/stakeholder/factor relationship table 651, the cosine similarity to terminology of the input node, for example.

Next, the data analysis requirement definition aid apparatus 401 determines whether there is an accumulated node with a degree of similarity greater than or equal to a threshold (step S1903). Next, the data analysis requirement definition aid apparatus 401 determines whether there is a challenge 1002 with a cosine similarity greater than or equal to a threshold. If there are no nodes with a degree of similarity greater than or equal to the threshold (step S1903: No), then the series of processes ends.

On the other hand, if there are nodes in which the degree of similarity of greater than or equal to the threshold (step S1903: Yes), the data analysis requirement definition aid apparatus 401 acquires a directed graph structure including accumulated nodes with a degree of similarity greater than or equal to the threshold (hereinafter referred to as similar accumulated nodes) (step S1904). Specifically, for example, the data analysis requirement definition aid apparatus 401 refers to the challenge relationship table 652 to create a directed graph structure of accumulated challenges in which the challenge ID 1001 of the similar accumulated node is the upper level challenge ID 1102 or the lower level challenge ID 1103. In the example of FIG. 1, accumulated challenges 101 and accumulated challenges 102 that include the challenge A, which is the similar node, are created.

Next, the data analysis requirement definition aid apparatus 401 determines whether two or more directed graph structures were acquired in step S1904 (step S1905). If the number of directed graph structures is not two or more (step S1905: No), this means that there is only one directed graph structure, and thus, the data analysis requirement definition aid apparatus 401 uses the display processing unit 630 to output the directed graph structure including the similar accumulated node to the terminal 402 as an accumulated challenge (step S1906).

On the other hand, if there are two or more directed graph structures (step S1905: Yes), then the data analysis requirement definition aid apparatus 401 searches for a path that is common to the two or more directed graph structures (hereinafter referred to as the common path) as a challenge common to the two or more accumulated challenges (common challenge) (step S1907).

Specifically, for example, the data analysis requirement definition aid apparatus 401 identifies the similar accumulated node for each of the two or more directed graph structures. Next, the data analysis requirement definition aid apparatus 401 searches for a node of the upper level challenge 1002 where the similar accumulated node is the lower level challenge 1002 for each of the two or more directed graph structures. Then, the data analysis requirement definition aid apparatus 401 calculates the cosine similarity between nodes of the upper level challenge 1002 for each of the two or more directed graph structures. If the cosine similarities between nodes of the upper level challenge 1002 are all greater than or equal to the threshold, then the data analysis requirement definition aid apparatus 401 searches for the node of the upper level challenge 1002 where the node of the upper level challenge 1002 is the node of the lower level challenge 1002. A trial run is performed of such a search until any of the cosine similarities between nodes of the upper level challenge 1002 falls below the threshold, or if there are no nodes of the upper level challenge 1002 among any of the two or more directed graph structures.

Similarly, the data analysis requirement definition aid apparatus 401 searches for a node of the upper level challenge 1002 where the similar accumulated node is the upper level challenge 1002 for each of the two or more directed graph structures. Then, the data analysis requirement definition aid apparatus 401 calculates the cosine similarity between nodes of the lower level challenge 1002 for each of the two or more directed graph structures. If the cosine similarities between nodes of the lower level challenge 1002 are all greater than or equal to the threshold, then the data analysis requirement definition aid apparatus 401 searches for the node of the lower level challenge 1002 where the node of the lower level challenge 1002 is the node of the upper level challenge 1002. A trial run is performed of such a search until any of the cosine similarities between nodes of the lower level challenge 1002 falls below the threshold, or if there are no nodes of the lower level challenge 1002 among any of the two or more directed graph structures.

In the example of FIG. 1, a common path constituted of node A→node B→node E is searched as a common challenge.

Then, the data analysis requirement definition aid apparatus 401 outputs a directed graph structure including the common path to the terminal 402 using the display processing unit 630, with the group of nodes searched in this manner and the edge between the nodes in the group of nodes being the common path.

The directed graph structure including the common path may be only the common path or may be a directed graph structure that is the logical OR of two or more directed graph structures where the common path is displayed with emphasis (and/or paths other than the common path are displayed with less emphasis). Also, the similar accumulated nodes included in the common path may be replaced by the input nodes. Furthermore, the similar accumulated nodes (or the replacement input nodes) may be displayed with emphasis in a different format than other nodes in the common path.

In the data analysis requirement definition aid example 1, a case was described in which the data analysis requirement definition aid apparatus 401 searches for the directed graph structure of challenges, but a directed graph structure of processes such as the to-be-considered processes 202 may be searched instead.

### Data Analysis Requirement Definition Aid Example 2

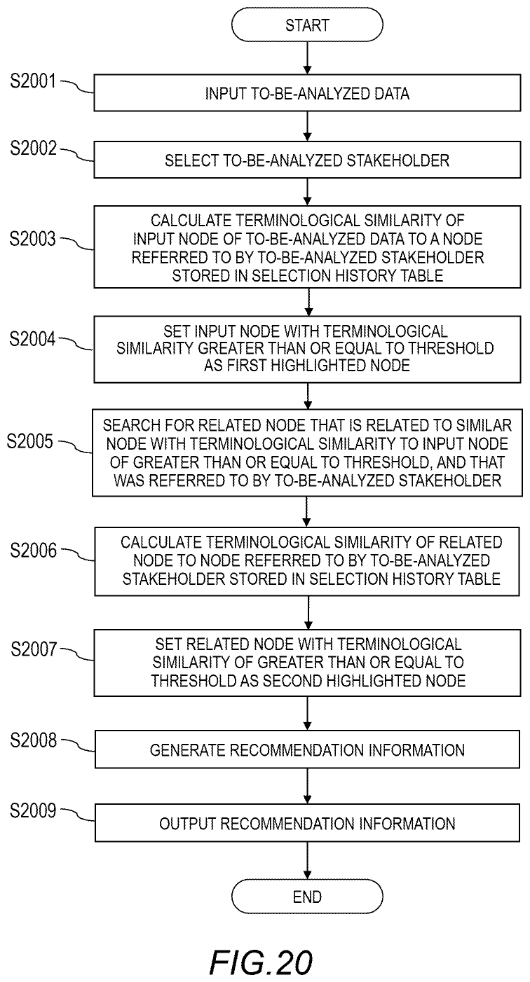

FIG. 20 is a flowchart showing data analysis requirement definition aid process method example 2. FIG. 20 shows a process method corresponding to the data analysis requirement definition aid example 2 shown in FIG. 2.

The data analysis requirement definition aid apparatus 401 receives input of the to-be-analyzed data 200 from the graph structure operation unit 600 through operation of the terminal 402 by the user (step S2001).

Next, the data analysis requirement definition aid apparatus 401 receives selection of a to-be-analyzed stakeholder through operation of the terminal 402 by the user (step S2002). Here, as shown in FIG. 2, the stakeholders A and B are selected by the user as to-be-analyzed stakeholders.

Next, the data analysis requirement definition aid apparatus 401 calculates, for input nodes of the to-be-analyzed data 200, the terminological similarity to nodes referred to by the to-be-analyzed stakeholders stored in the selection history table 672 (step S2003). The terminological similarity is, as described above, the cosine similarity, for example. The input nodes of the to-be-analyzed data 200 are the nodes depicted as rounded rectangles of the to-be-considered challenges 201 included in the to-be-analyzed data 200 (challenges 1 to 5 in FIG. 2) or nodes represented as rectangles or diamonds in the to-be-considered challenges 1922 (processes 1 to 3, factors 1 to 3 in FIG. 2).

The nodes referred to by the to-be-analyzed stakeholders stored in the selection history table 672 are nodes where the user ID 1701 of the selection history table 672 is the stakeholder ID 701 of the to-be-analyzed stakeholder, and are the challenge 1002, the process 1302, and the factor 1502 identified, respectively, by the challenge ID 1001, the process ID 1301, and the factor ID 1501 recorded in the selection item 1802.

If there are a plurality of to-be-analyzed stakeholders, then the nodes referred to by the to-be-analyzed stakeholders stored in the selection history table 672 may be nodes referred to by the plurality of to-be-analyzed stakeholders or nodes referred to be any of the plurality of to-be-analyzed stakeholders. The user can set conditions in advance for when there are a plurality of to-be-analyzed stakeholders. In the example of FIG. 2, if there are a plurality of to-be-analyzed stakeholders, then the nodes referred to by the to-be-analyzed stakeholders stored in the selection history table 672 are set to be nodes referred to by the plurality of to-be-analyzed stakeholders.

Next, the data analysis requirement definition aid apparatus 401 sets the input node where the terminological similarity to the node of the to-be-analyzed stakeholder is greater than or equal to a threshold as a first highlighted node (step S2004). In the example of FIG. 2, the nodes referred to by the stakeholders A and B in the to-be-analyzed data 200 are the challenge 4 and the process 2. The data analysis requirement definition aid apparatus 401 sets the challenge 4 and the process 2 as the first highlighted nodes.

Next, the data analysis requirement definition aid apparatus 401 searches for a node (hereinafter referred to as the related node) that is related to a node where the terminological similarity to the input node is greater than or equal to a threshold (hereinafter referred to as the similar node) and that was searched by the to-be-analyzed stakeholder (step S2005). If the input node is a challenge, for example, then the related nodes are the upper level challenge or the lower level challenge to the challenge indicated by the input node, a control factor or an objective variable factor of the challenge indicated by the input node, and the control factor or the objective variable factor of the upper level challenge or the lower level challenge of the challenge indicated by the input node.

Also, if the input node is a process, for example, then the related nodes are the pre-process or the post-process to the process indicated by the input node, an input factor or an output factor of the process indicated by the input node, and the input factor or the output factor of the pre-process or the post-process of the process indicated by the input node. The data analysis requirement definition aid apparatus 401 searches the related nodes with reference to the challenge/stakeholder/factor relationship table 651, the challenge relationship table 652, the process/stakeholder/factor relationship table 661, the process relationship table 662, the factor table 663, and the selection history table 672.

Next, the data analysis requirement definition aid apparatus 401 calculates, for the related nodes, the terminological similarity to nodes referred to by the to-be-analyzed stakeholders stored in the selection history table 672 (step S2006). The terminological similarity is, as described above, the cosine similarity, for example.

Next, the data analysis requirement definition aid apparatus 401 sets the related node where the terminological similarity to the node referred to by the to-be-analyzed stakeholder is greater than or equal to a threshold as a second highlighted node (step S2007). In the example of FIG. 2, the related nodes are the challenge 6 and the factor 5. The data analysis requirement definition aid apparatus 401 sets the challenge 6 and the factor 5 as the first highlighted nodes.

Next, the data analysis requirement definition aid apparatus 401 generates recommendation information (step S2008). Specifically, for example, the data analysis requirement definition aid apparatus 401 adds the challenge 6 to the to-be-considered challenges 201 and updates the to-be-considered challenges 201 to the to-be-considered challenges 211, and generates the to-be-considered challenges 211 with the challenges 4 and 6 being displayed with emphasis. Also, the data analysis requirement definition aid apparatus 401 generates to-be-considered processes 212 while displaying the process of the to-be-considered processes 202 with emphasis. Additionally, the data analysis requirement definition aid apparatus 401 is constituted of processes 2 and 3 included in the to-be-considered processes 202, a process 4, which is a related node to the process 3, a factor 4, which is an input factor to the process 4, and a factor 5, which is an output factor from the process 4, and generates another set of to-be-considered processes 213 in which the factor 5 is displayed with emphasis.

Next, the data analysis requirement definition aid apparatus 401 outputs the generated recommendation information 220 to the terminal 402 so as to be displayable therein (step S2009). Specifically, for example, the data analysis requirement definition aid apparatus 401 outputs the to-be-considered challenges 211, the to-be-considered processes 212, and the other set of to-be-considered processes 213 as recommendation information 220 to the terminal 402 so as to be displayable therein.

### Data Analysis Requirement Definition Aid Example 3

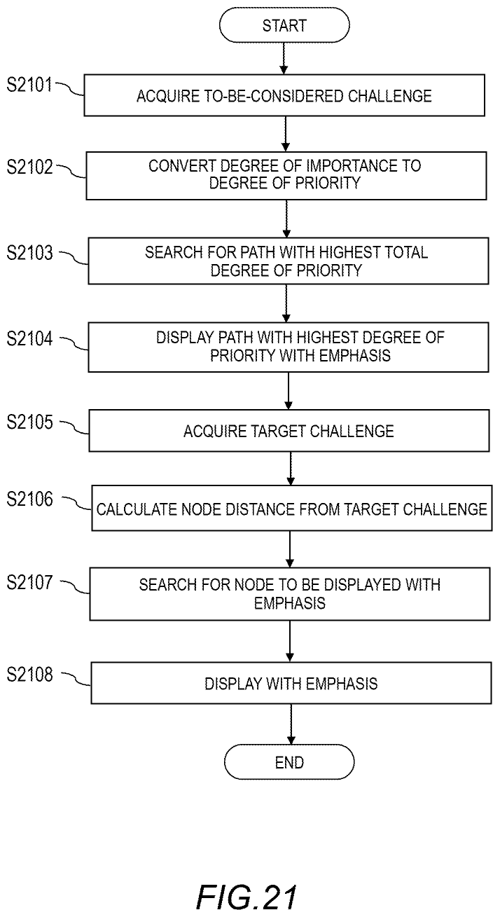

FIG. 21 is a flowchart showing data analysis requirement definition aid process method example 3. FIG. 21 shows a process method corresponding to the data analysis requirement definition aid example 3 shown in FIG. 3.

The data analysis requirement definition aid apparatus 401 acquires the to-be-considered challenges from the terminal 402 (step S2101). In the example of FIG. 2, the data analysis requirement definition aid apparatus 401 acquires the to-be-considered challenges 301 from the terminal 402. The data analysis requirement definition aid apparatus 401 may read the directed graph structure of the to-be-considered challenges 301 created by a user in the past from the storage device 502 or may search for the directed graph structure of the to-be-considered challenges 301 with a node indicating a given challenge as the retrieval key, for example. The edges of the to-be-considered challenges 301 are assigned a degree of importance by the user.

Next, as shown in FIG. 3, the data analysis requirement definition aid apparatus 401 converts the degree of importance of the to-be-considered challenges 301 to the degree of priority 1201 (step S2102). The data analysis requirement definition aid apparatus 401 assigns a priority ID 1104 identifying the converted degree of priority 1201, records the same in the challenge relationship table 652, and records the degree of priority 1201 and the priority ID 1104 in the challenge priority table 653. Also, if priority IDs 1104 are already assigned to each edge of the to-be-considered challenges 301 (upper level challenge ID 1102 and lower level challenge ID 1103), then a degree of importance is not assigned to the to-be-considered challenges 301, and the data analysis requirement definition aid apparatus 401 reads the degree of priority 1201 from the challenge priority table 653.

Next, the data analysis requirement definition aid apparatus 401 searches for a path where the total degree of priority in the to-be-considered challenges 310 reaches a maximum (step S2103). In the example of FIG. 3, the total degree of priority for A→C→F is “8.1,” and is searched as the path with the maximum total degree of priority.

Next, the data analysis requirement definition aid apparatus 401 outputs the to-be-considered challenges 310 to the terminal 402 so as to be displayable therein, such that the path with the maximum total degree of priority is displayed with emphasis (step S2104).

Next, the data analysis requirement definition aid apparatus 401 acquires the target challenge through selection from the terminal 402 (step S2105). In the example of FIG. 3, the target challenge is the node E. The data analysis requirement definition aid apparatus 401 sets the node distance of the node E, which is the target challenge, to “0,” which indicates the starting point.

Next, the data analysis requirement definition aid apparatus 401 calculates the node distance to each node from the target challenge (step S2106). The node distance is calculated by adding 1 every time each edge is traversed.

Next, the data analysis requirement definition aid apparatus 401 searches for a node where the degree of priority is greater than or equal to a threshold and having a node distance of less than or equal to a prescribed distance (step S2107). In the example of FIG. 3, the node F is searched.

Next, the data analysis requirement definition aid apparatus 401 additionally outputs the to-be-considered challenges 320 to the terminal 402 so as to be displayable therein, such that the node F is displayed with emphasis (step S2108).

In the data analysis requirement definition aid example 3, a case was described in which the data analysis requirement definition aid apparatus 401 displays the values of challenges using the directed graph structure of challenges, but the values of processes may be displayed instead using the directed graph structure of processes such as the to-be-considered processes 202.

Thus, according to the present embodiment, if it is unclear how the structure should be configured, it is possible to propose to the user the common challenges 103 including a common path that is common to the accumulated challenges as a similar challenge structure, through the data analysis requirement definition aid example 1, which is a recommendation technique that analogizes from other cases.

As a result of the data analysis requirement definition aid example 2, which is a highlighting technique based on the ideas of another person if it is unknown which part of the information should be noted, the user is able to know which items among the to-be-analyzed data 200 were viewed by the stakeholders A and B who have a vested interest. Also, the user is able to know which items among other considerations were viewed by the stakeholders A and B who have a vested interest.

Also, the user can understand which connections of challenges are important through the data analysis requirement definition aid example 3, which is a rating technique of performing matching to business value if a match cannot be made to the challenge value of the user's technical field.

In this manner, the data analysis requirement definition aid apparatus 401 can aid the structuring of information for quickly and effectively defining requirements for new cases through the data analysis requirement definition aid examples 1 to 3. Thus, even if the challenge candidate to be considered changes, for example, it is possible to simultaneously compare related stakeholders and processes related thereto, and it is possible to propose portions of the process to consider and data necessary for consideration over multiple different business areas.

The data analysis requirement definition aid apparatus 401 may confirm whether there are inadequacies between nodes of the directed graph structure, and if there is an inadequacy, output to the terminal 402, in a displayable manner, a warning indicating that there is an inadequacy between nodes.

Specifically, if adding a new node, for example, the process differs for the directed graph structures of stakeholders, challenges, and processes, respectively. In the case of a directed graph structure of stakeholders, for example, if no bidirectional edge is defined between nodes indicating stakeholders (only an arrow in one direction), then the data analysis requirement definition aid apparatus 401 considers that payment on a bill was not made, and outputs a warning to the terminal 402 in a displayable manner.

In the case of a directed graph structure of challenges, the data analysis requirement definition aid apparatus 401 outputs a warning indicating whether there is an additional edge connecting the nodes in a displayable manner to the terminal 402 if no edge is defined between nodes indicating a challenge or if an edge in only one direction is defined.

In the case of a directed graph structure of processes, the data analysis requirement definition aid apparatus 401 outputs a warning indicating whether there is an additional edge connecting the nodes in a displayable manner to the terminal 402 if no edge is defined between nodes indicating a challenge or if an edge in only one direction is defined. Also, the data analysis requirement definition aid apparatus 401 outputs, in a displayable manner to the terminal 402, a warning indicating whether there is a lacking factor for nodes not connected to factors.

The terminal 402 to receive the warning display adds lacking edges or factors through user operation. As a result, the data analysis requirement definition aid apparatus 401 reflects the added edges or factors from the terminal 402. In this manner, it is possible to aid the structuring of information for quickly and effectively defining requirements for new cases while mitigating a lack of data.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A data analysis requirement definition aid apparatus, comprising:
a processor configured to execute a program; and
a storage device configured to store the program,
wherein the storage device configures to store a plurality of nodes that each include a character string, and an edge indicating a relationship between two nodes among the plurality of nodes, and
wherein the processor configures to execute:
an input process of receiving input of a to-be-analyzed node;
a retrieval process of retrieving, from among the plurality of nodes, a similar node including a character string similar to the character string of the to-be-analyzed node inputted by the input process;
an acquisition process of acquiring a directed graph structure constituted of a group of nodes including the similar node retrieved through the retrieval process, and an edge between two nodes among the group of nodes;
a search process of searching for a path including the similar node from the directed graph structure acquired by the acquisition process; and
an output process of outputting, in a displayable manner, the directed graph structure so as to display a path found by the search process in a different format.

2. The data analysis requirement definition aid apparatus according to claim 1,
wherein, in the acquisition process, the processor acquires a plurality of the directed graph structures, and
wherein, in the search process, the processor searches for the path common to the plurality of directed graph structures.

3. A data analysis requirement definition aid apparatus, comprising:
a processor configured to execute a program; and
a storage device configured to store the program,
wherein the storage device configured to store a plurality of nodes that each include a character string, an edge indicating a relationship between two nodes among the plurality of nodes, and a history of the nodes referred to by a to-be-analyzed person, and
wherein the processor configured to execute:
an input process of receiving input of a first to-be-analyzed directed graph structure constituted of a to-be-analyzed group of nodes and an edge indicating a relationship between two nodes among the to-be-analyzed group of nodes;
a first retrieval process of retrieving, from among the plurality of nodes, a first similar node that was referred to by the to-be-analyzed person and that is similar to the character string of each to-be-analyzed node among the to-be-analyzed group of nodes that constitutes the first to-be-analyzed directed graph structure inputted by the input process;
a first setting process of setting, as a first specific display object, a first similar to-be-analyzed node that is similar to the first similar node retrieved by the first retrieval process among the to-be-analyzed group of nodes; and
an output process of outputting, in a displayable manner, the first to-be-analyzed directed graph structure so as to display the first specific display object set by the first setting process in a different format.

4. The data analysis requirement definition aid apparatus according to claim 3,
wherein the processor configured to execute:
a search process of searching, from among the plurality of nodes, a related node that is related to the first similar node via the edge, and that is outside of the to-be-analyzed group of nodes referred to by the to-be-analyzed person;
a second retrieval process of retrieving, from among the plurality of nodes, a second similar node that was referred to by the to-be-analyzed person and that is similar to the character string of the related node that was searched by the search process;
a second setting process of setting, as a second specific display object, a second similar to-be-analyzed node that is similar to the second similar node retrieved by the second retrieval process among the to-be-analyzed group of nodes; and
an update process of updating the first to-be-analyzed directed graph structure by adding the second specific display object set by the second setting process to the first to-be-analyzed directed graph structure, and
wherein, in the output process, the processor configured to execute outputting, in a displayable manner, the first to-be-analyzed directed graph structure so as to display the first specific display object and the second specific display object in different formats.

5. The data analysis requirement definition aid apparatus according to claim 3,
wherein the processor configured to execute:
a search process of searching, from among the plurality of nodes, a related node that is related to the first similar node via the edge, and that is outside of the to-be-analyzed group of nodes referred to by the to-be-analyzed person;
a second retrieval process of retrieving, from among the plurality of nodes, a second similar node that was referred to by the to-be-analyzed person and that is similar to the character string of the related node that was searched by the search process;
a second setting process of setting, as a second specific display object, a second similar to-be-analyzed node that is similar to the second similar node retrieved by the second retrieval process among the to-be-analyzed group of nodes; and
a generating process of generating a second to-be-analyzed directed graph structure including the second specific display object set by the second setting process and the to-be-analyzed node related via the edge to the second specific display object, and
wherein, in the output process, the processor configured to execute outputting, in a displayable manner, the first to-be-analyzed directed graph structure and the second to-be-analyzed directed graph structure so as to display the first specific display object and the second specific display object in different formats.

6. A data analysis requirement definition aid apparatus, comprising:
a processor configured to execute a program; and
a storage device configured to store the program,
wherein the storage device configures to store a plurality of nodes that each include a character string, and an edge indicating a relationship between two nodes among the plurality of nodes, and
wherein the processor configured to execute:
an input process of receiving input of a to-be-analyzed directed graph structure constituted of a to-be-analyzed group of nodes and an edge indicating a relationship between two nodes among the to-be-analyzed group of nodes;
an acquisition process of acquiring a degree of priority of the edge;
a first search process of searching for a path having a greatest total degree of priority of the edges, from among the to-be-analyzed directed graph structure, on the basis of the degree of priority acquired by the acquisition process for each edge of the to-be-analyzed directed graph structure inputted by the input process; and
an output process of outputting, in a displayable manner, the to-be-analyzed directed graph structure so as to display a path found by the first search process in a different format.

7. The data analysis requirement definition aid apparatus according to claim 6,
wherein the processor configured to execute:
a selection process of receiving selection of a specific to-be-analyzed node from among the to-be-analyzed group of nodes;
a calculation process of calculating a distance from the specific to-be-analyzed node selected by the selection process to another to-be-analyzed node other than the specific to-be-analyzed node; and
a second search process of searching for a specific display object on the basis of the degree of priority of the edge to said another to-be-analyzed node and the distance calculated by the calculation process, and
wherein, in the output process, the processor configured to output, in a displayable manner, the to-be-analyzed directed graph structure so as to display the path and the specific display object found by the second search process.

8. A data analysis requirement definition aid method performed by a data analysis requirement definition aid apparatus having a processor configured to execute a program, and a storage device configured to store the program,
wherein the storage device configured to store a plurality of nodes that each include a character string, and an edge indicating a relationship between two nodes among the plurality of nodes, and
wherein, in the method, the processor executes:
an input process of receiving input of a to-be-analyzed node;
a retrieval process of retrieving, from among the plurality of nodes, a similar node including a character string similar to the character string of the to-be-analyzed node inputted by the input process;
an acquisition process of acquiring a directed graph structure constituted of a group of nodes including the similar node retrieved through the retrieval process, and an edge between two nodes among the group of nodes;
a search process of searching for a path including the similar node from the directed graph structure acquired by the acquisition process; and
an output process of outputting, in a displayable manner, the directed graph structure so as to display a path found by the search process in a different format.

9. A data analysis requirement definition aid method performed by a data analysis requirement definition aid apparatus having a processor configured to execute a program, and a storage device configured to store the program,
wherein the storage device configured to store a plurality of nodes that each include a character string, an edge indicating a relationship between two nodes among the plurality of nodes, and a history of the nodes referred to by a to-be-analyzed person, and
wherein, in the method, the processor executes:
an input process of receiving input of a first to-be-analyzed directed graph structure constituted of a to-be-analyzed group of nodes and an edge indicating a relationship between two nodes among the to-be-analyzed group of nodes;
a first retrieval process of retrieving, from among the plurality of nodes, a first similar node that was referred to by the to-be-analyzed person and that is similar to the character string of each to-be-analyzed node among the to-be-analyzed group of nodes that constitutes the first to-be-analyzed directed graph structure inputted by the input process;
a first setting process of setting, as a first specific display object, a first similar to-be-analyzed node that is similar to the first similar node retrieved by the first retrieval process among the to-be-analyzed group of nodes; and
an output process of outputting, in a displayable manner, the first to-be-analyzed directed graph structure so as to display the first specific display object set by the first setting process in a different format.

10. A data analysis requirement definition aid method performed by a data analysis requirement definition aid apparatus having a processor that executes a program, and a storage device that stores the program,
wherein the storage device stores a plurality of nodes that each include a character string, an edge indicating a relationship between two nodes among the plurality of nodes, and a degree of priority of the edge, and
wherein, in the method, the processor executes:
an input process of receiving input of a to-be-analyzed directed graph structure constituted of a to-be-analyzed group of nodes and an edge indicating a relationship between two nodes among the to-be-analyzed group of nodes;
a first search process that searches for a path having a greatest total degree of priority of the edges, from among the to-be-analyzed directed graph structure, on the basis of the degree of priority of each edge of the to-be-analyzed directed graph structure inputted by the input process; and
an output process of outputting, in a displayable manner, the to-be-analyzed directed graph structure so as to display a path found by the first search process in a different format.
